(19) United States
(12) Patent Application Publication
(10) Pub. No.: US 2008/0183681 A1
(43) Pub. Date: Jul. 31, 2008

(54) METHOD AND SYSTEM FOR FACILITATING INFORMATION SEARCHING ON ELECTRONIC DEVICES

(75) Inventors: Alan Messer, Los Gatos, CA (US); Doreen Cheng, San Jose, CA (US); Anugeetha Kunjithapatham, Sunnyvale, CA (US); Phuong Nguyen, San Jose, CA (US); Priyang Rathod, Mountain View, CA (US); Mithun Sheshagiri, Mountain View, CA (US); Simon J. Gibbs, San Jose, CA (US)

Correspondence Address: MYERS DAWES ANDRAS & SHERMAN, LLP, 19900 MACARTHUR BLVD., SUITE 1150, IRVINE, CA, 92612, US

(73) Assignee: Samsung Electronics Co., Ltd., Suwon City (KR)

(21) Appl. No.: 12/056,184

(22) Filed: Mar. 26, 2008

Related U.S. Application Data
(63) Continuation-in-part of application No. 11/969,778, filed on Jan. 4, 2008.
(60) Provisional application No. 60/898,257, filed on Jan. 29, 2007.

(51) Int. Cl. G06F 7/00

(52) U.S. Cl. 707/3

(57) ABSTRACT

A method and a system for facilitating information searching for a user of an electronic device, is provided. Search facilitation involves forming a query to search for information related to the user activity on the electronic device; resolving the query by searching available sources including one or more external sources for the related information; receiving an event indicating availability of related information; and providing the related information to the user.

### RELATED APPLICATIONS

This application is a continuation-in-part of U.S. patent application Ser. No. 11/969,778, filed on Jan. 4, 2008, which in turn claims priority from U.S. Provisional Patent Application Ser. No. 60/898,257 filed on Jan. 29, 2007, incorporated herein by reference.

### FIELD OF THE INVENTION

The present invention relates to providing relevant information to users, and in particular to providing relevant information to users with reduced user input.

### BACKGROUND OF THE INVENTION

The Internet has become a popular source of entertainment and information. Most Internet content is designed for access via a web browser, making it difficult for access via most consumer electronics (CE) devices which lack typical computer keyboards. As a result, the Internet is generally restricted to access on personal computers (PC) or via cumbersome interfaces on CE devices.

With advances in hardware and software technologies, CE devices are becoming more powerful. Growth in network infrastructure and the falling prices of hardware have increased the availability of network-capable entertainment devices. Many users are configuring home networks including cable set-top boxes, digital television sets, home media servers, digital audio players, personal video recorders, etc. Home network consumers are also creating, storing and accessing more digital content through CE devices and PCs.

A second trend, running in parallel to the emergence of networked entertainment devices, is the growing use of the Internet for creating and publishing content. Greater broadband penetration and falling memory prices are enabling users to move ever larger media files, such as television (TV) shows and full-length movies, through the Internet.

However, there is a gap between the digital content on the Internet and the networked digital entertainment devices in that most Internet content is structured and organized for access via a web browser not a typical CE device. For example, typically a user searches for Internet information using a search engine or by directly accessing a known website via a PC. When using a search engine, the user is required to form an initial query and then iteratively refine the query depending upon the results obtained. As such, the user is forced to comprehend and analyze large quantities of information to identify/access the exact information the user is looking for. This process may work on a PC, but on CE devices that lack a keyboard and a mouse, the searching/refinement process is awkward and unpleasant. Moreover, users typically expect a “lean-back” experience when it comes to using CE devices in their homes and home networks. For instance, someone watching a television news program on a television may not be inclined to conduct an Internet search if such a search requires any effort more than pushing a few buttons on a remote control.

### BRIEF SUMMARY OF THE INVENTION

The present invention provides a method and system for facilitating information searching for a user of an electronic device. One embodiment involves forming a query to search for information related to the user activity on the electronic device; resolving the query by searching available sources including one or more external sources for said related information; receiving an event indicating availability of related information; and providing the related information to the user.

Resolving the query may further include searching said available sources, and providing extracted related information to the user. Further, receiving an event indicating availability of the related information may further include receiving an event indicating availability of additional related information. In addition, providing the related information to the user may further include providing said additional related information to the user.

These and other features, aspects and advantages of the present invention will become understood with reference to the following description, appended claims and accompanying figures.

### BRIEF DESCRIPTION OF THE DRAWINGS

FIG. 1 shows a network implementing a process for facilitating information searching for users, according to an embodiment of the present invention.

FIG. 2 shows an example architecture for facilitating information searching, according to the invention.

FIG. 3 shows a flowchart of the overall steps involved in facilitating information searching, according to the invention.

FIG. 4 shows an example of keyword selection, according to the invention.

FIG. 5 shows an example of tokenizing, according to the invention.

FIG. 6 shows an architecture of facilitating searching using execution plans, according to an embodiment of the invention.

FIG. 7 shows an alternative architecture of facilitating searching using execution plans, according to the invention.

FIG. 8 shows a flowchart of the steps of a search facilitation process implemented by the alternative architecture of FIG. 7, according to an embodiment of the present invention.

FIG. 9 shows an example screen shot of a user interface facilitating information searching, according to the invention.

### DETAILED DESCRIPTION OF THE INVENTION

The present invention provides a method and system for facilitating access to information via electronic devices such as consumer electronic (CE) devices. One embodiment involves enabling home users to easily find and access Internet content related to content presented on a CE device. An example is enabling a user to easily find and access Internet content related to a program the user is watching on a television. The user is now able to access relevant information and video content on the Internet in a “lean-back” living room experience while watching TV.

Searching for information on the Internet typically involves two stages: search query formation, and data search and analysis. Query information involves forming a search query that describes the type of information being sought. Data search and analysis involves resolving the search query according to the following steps: potential sources of data are identified; relevant data from such sources are extracted via search queries and then aggregated (collected); and correlations in the form of associations among the aggregated data are identified to make the results more meaningful.

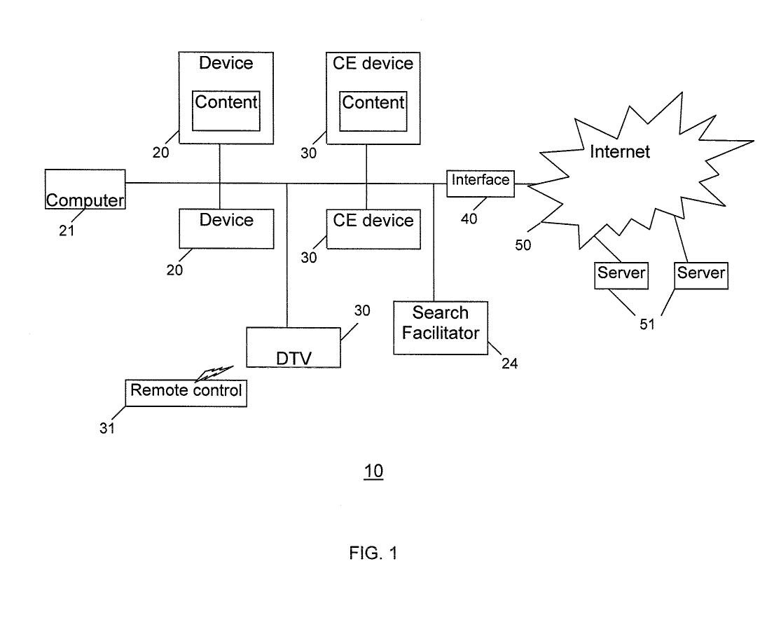

An example implementation for CE devices in a local area network (LAN), such as a home network, is described below, however the present invention is useful with other electronic devices, and electronic devices that are not in a LAN but have access to the Internet. FIG. 1 shows a functional architecture of an example network/system 10, such as a LAN of home devices, embodying aspects of the present invention. The network/system 10 comprises devices 20 such as appliances, a personal computer (PC) 21, CE devices 30 which may include content, and an interface 40 that connects the network/system 10 to an external network 50 (e.g., another local network, the Internet). The external network 50 can be connected to one or more servers 51. The network/system 10 can implement the Universal Plug and Play (UPnP) protocol or other network communication protocols (e.g., Jini, HAVi, IEEE 1394, etc.). The network/system 10 can be a wireless network, a wired network, or a combination thereof. Examples of CE devices include digital televisions (DTVs, PDAs, media players, etc.).

The network 10 further includes a search facilitator system 24 that provides searching, aggregation and analysis functions. The facilitator 24 performs query formation, data search and analysis, wherein query formation includes identifying potential search queries (i.e., potential data of interest to the user) based on the user's context. Further, data search and analysis includes extracting, aggregating and correlating data of interest using execution plans.

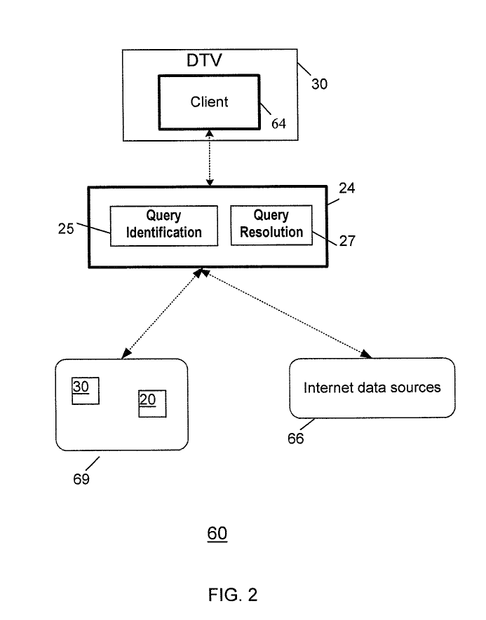

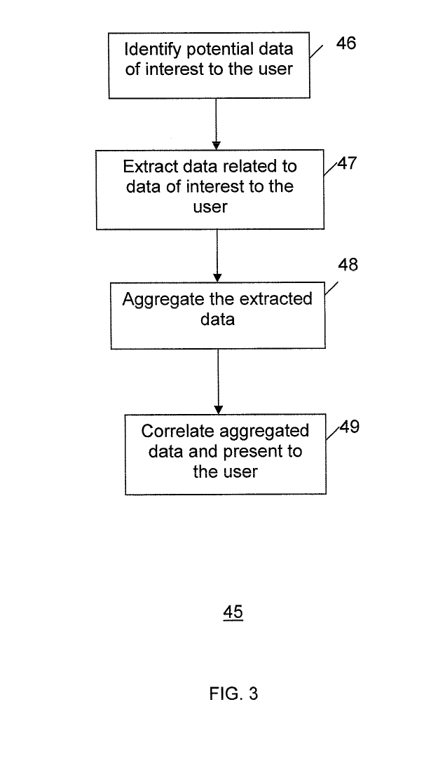

FIG. 2 shows an architecture 60 including the facilitator 24, according to an embodiment of the present invention. The architecture 60 implements searching, aggregation and analysis functions via the facilitator 24, to provide information to a user through a user interface of a client module 64 that, in this example, is implemented in a CE device such as the DTV 30. Referring to the example process 45 in FIG. 3, in order to free users from the involved process of query formation, the facilitator 24 identifies potential data of interest to the user (step 46), extracts data related to data of interest to the user (step 47), aggregates the extracted data (step 48) and correlates the said related data to present to the user (step 49).

Information of interest to the user, or user-related information, may include one or more of: user profile, user preferences, content previously/currently accessed by the user, terms previously selected by the user, etc.

In one example, the client module 64 enables the user to obtain desired information from, e.g., the Internet using a simple and intuitive Graphical User Interface (GUI) application, utilizing the facilitator 24, including:
1. Mapping the functionalities that support an information search to a small number of keys (e.g., mapping such functionalities to a few keys of a TV remote control 31 (FIG. 1), as an example for receiving user input when using a DTV 30 for information access).
2. Enabling the user to express interest in obtaining additional information related to information currently accessed by the user (e.g., providing an “info.” button on the remote control 31 for the user to press, and mapping this action into a “more info” request, etc.).
3. Enabling the user to indicate the specific type of additional information the user is looking for, after the user has expressed interest in accessing additional information. An example involves displaying a set of keywords related to the data that the user has expressed interest in (e.g., a TV program or media content the user is accessing). Then, providing a combination of keys (e.g., up/down/right/left arrow keys) on a remote control 31 for the user to select one of the keywords as a search query.
4. Enabling the user to refine or edit a suggested keyword/search query, such as by displaying a set of additional query suggestions that contain, or are related to, the selected keyword and providing a combination of the arrow keys (up/down/right/left arrows) on the remote control 31 for the user to select one of the query suggestions. The GUI allows the user to refine the search queries as many times as the user desires by just repeating the process described above. Further, the query suggestions are displayed in an editable text box that allows the user to delete existing characters or enter new characters to modify the query as desired. This can be performed using, e.g., a wireless keyboard or a remote control that has an inbuilt keypad.
5. Performing a search based on a formulated query. Then, enabling the user to access the search results by displaying a list of search results corresponding to the keyword previously selected by the user. Then, providing a combination of arrow keys (up/down/right/left arrows) on the remote control device 31 for the user to select one of the refined search results. An example of a search result includes a link to a web page containing information about the search query, wherein the title of the web page is displayed to the user on the GUI.

The user utilizes the client module 64 to access certain content, and the facilitator 24 obtains information related to the accessed content for display to the user. The user then requests that the facilitator 24 provide more information about the accessed content. For example, the user utilizes the client module 64 to request that the facilitator 24 provide more information from Internet data sources 66 about a pre-recorded/broadcast TV program the user is watching on the DTV 30.

Using the client module 64, the user can choose, edit or enter new queries (such as the suggested keywords/categories) with minimal effort on a CE device that may not have a keyboard/mouse. Specifically, the facilitator 24 suggests and displays queries including keywords related to the TV program and information categories related to those keywords. Using the suggested keywords and categories as search queries, users can seamlessly browse/search for related information available on the Internet through their CE devices by simply selecting among the suggested queries for searching. The facilitator 24 identifies many relevant search queries, and allows the user to edit a suggested query or enter a new query. The facilitator 24 then obtains information of interest to the user and presents such information to the user.

In the architecture shown in FIG. 2, the facilitator 24 includes a query identification function 25 and a query resolution function 27, which implement the above steps. Specifically, the query identification function 25 identifies potential data of interest to the user. The query resolution function 27 extracts identified data of potential interest to the user (e.g., from local sources 69 and/or Internet sources 66), aggregates the extracted data and correlates the aggregated data for presentation to the user. The operations of the query identification function 25 and the query resolution function 27 are described below.

In one example, the query identification function 25 identifies potential data of interest to the user, based on the user's current application state. Current application state refers to the state of the application that the user is using at the time the user desires to access relevant Internet content. For example, if the user is watching a television program on DTV 30, the channel the DTV is tuned to and the program being broadcast, constitute the application state.

The query identification function 25 identifies the content used/rendered by the application. Then, the query identification function 25 obtains metadata information and/or other associated data for the content being accessed, and identifies potential search queries that might represent the data of interest to the user. When a user accesses content that has structured meta-data available, the query identification function 25 directly uses field/value pairs from the metadata as potential search queries. For example, if a user is listening to a music album by the artist “Sting” and expresses interest to access related content, the query identification function 25 obtains the following fields from the album's metadata (content=“MusicAlbum” & artist=“Sting”) and using these, the query identification function 25 infers that the user might be interested to access more albums by the same artist and suggests (MusicAlbum, artist, “Sting”) as one of the search queries to the user.

When a user accesses content such as broadcast TV programs and DVDs, the query identification function 25 uses the caption data (closed captions), that is embedded in the content stream, to identify potential search queries. This embedded caption data contains useful information in the form of keywords. When a user watches a TV program and expresses interest to access related content, the query identification function 25 analyzes the TV program's caption text to identify significant keywords and suggests them to the user as possible search queries.

The query identification function 25 can be implemented, e.g., in a stand-alone module, in a device 20 such as a set-top box or in a CE device 30 such as a DTV. A user interface (UI) can be displayed on a device in the network/system 10 capable of displaying information, such as a CE device 30. An example of identifying keywords and suggesting them as possible search keywords by the query identification function 25 utilizing natural language processing (NLP) to analyze closed captions and identify keywords from the captions, is described below.

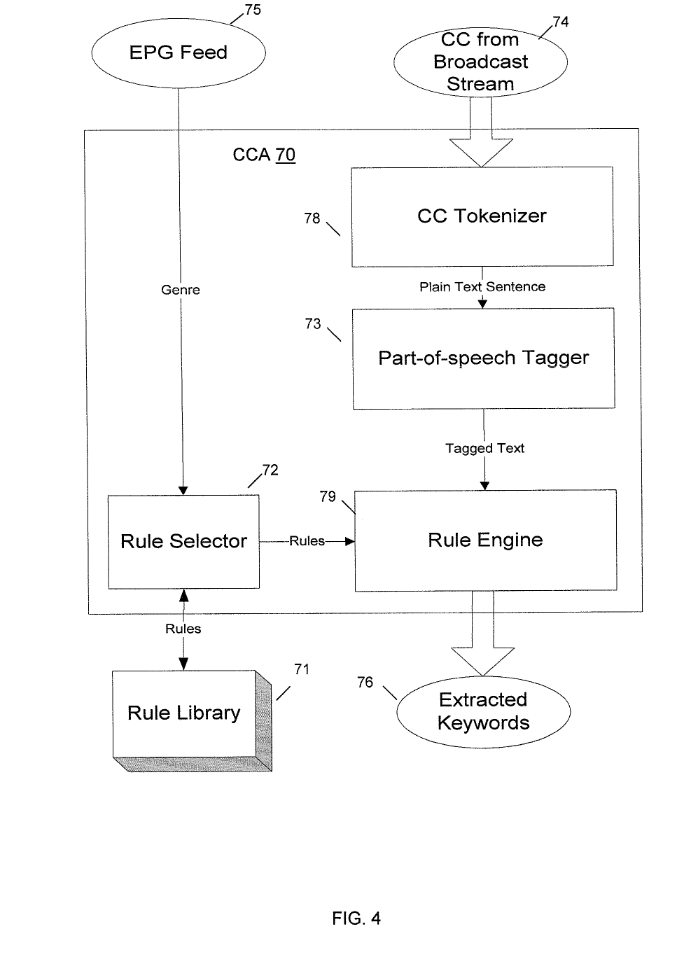

The closed captions (CC) of a TV program are embedded in the TV signal by the content provider before it is broadcast. They are primarily for the benefit of the hearing impaired. Extracting useful information from this text is not straightforward. The captions typically do not contain any case information, precluding any attempt to extract proper nouns based on case information. Also, they are often ungrammatical (e.g., because of the spoken nature of the content), poorly punctuated and may have typos. Because of these limitations, typical keyword extraction techniques used for text documents may not be suitable for closed caption text. In addition, the content of closed captions is highly dependent on the type of the program. A news program's captions are high-content and factual, whereas a sitcom's captions are typically low on content and full of slang. FIG. 4 shows a closed caption analyzer (CCA) 70 according to an embodiment of the present invention. The CCA extracts search queries from closed captions of a program using NLPs techniques and the Electronic Program Guide (EPG) information 75 to customize the extraction mechanism for different types of programs.

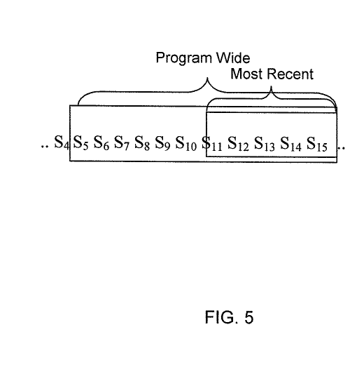

The CCA 70 operates in real-time on broadcast signals and processes a steady stream of closed caption text 74 entering the system. The CCA maintains two history windows over the stream of incoming text (FIG. 5). The smaller, most recent window, spans the last N (N=5 in our prototype) sentences (Sᵢ) and the larger program wide window covers the entire TV program/current news story/current program section, etc. Only the keywords extracted from the program wide window are stored and indexed for recommendation. Also, the keywords extracted from the most recent window are ranked higher than others, such that the most recent keywords appear at the top of the list of keywords presented to the user. As soon as the program or the news story changes (indicated either by special characters in the closed captions, such as ‘>>>’ in the U.S., or determined by looking at the EPG and the current time) both the windows are flushed and restarted.

A CC Tokenizer 78 receives the stream of CC text 74 and breaks it down into sentences. This is done in order to preserve the grammar of the text. A tagger 73 then tags sentences, e.g., using Brill's part-of-speech tagging. The tagger 73 analyzes the sentence and determines how each word is used in the sentence. The tagger 73 uses lexical rules to assign an initial tag to each word in a sentence, and then uses contextual rules to update the tag based on the context in which the word occurs. The contextual rules are sensitive to the grammar of the input sentence. Ungrammatical or incomplete sentences may result in incorrect tagging of the words in the sentence.

In one example, for an input sentence: “John Wayne ran home”:

The output of tagger 73 would be:
John<PROP> Wayne<PROP> ran<VB_PST> home<NOUN>

This indicates that in the previous sentence, “John” and “Wayne” are used as proper nouns, “ran” is a verb in past tense and “home” is a noun.

This tagged sentence from the tagger 73 is then passed on to a rule engine 79 which extracts keywords from the tagged sentence based on extraction policy rules from a rule library 71. A rule library 71, R, is an exhaustive set of rules that can be used to extract different kinds of phrases appearing in the sentence. The rules are represented as tag patterns. For example, it may have a rule to extract consecutive proper nouns (<PROP>+) and another rule to extract an adjective followed by one or more nouns (<ADJ><NOUN>+), etc. A rule selector 72 includes a mapping from genre to an extraction policy. The genre of the program being watched determines the type of keywords to extract from the captions. For example, if the program being watched is a high-content, factual program such as news, the extraction policy is highly aggressive, essentially extracting additional differing types of keywords (e.g., sequences of nouns, compound nouns, proper nouns etc.). On the other hand, if the program is a low-content, non-factual program such as a sitcom, a very conservative extraction policy is used, extracting keywords very selectively, extracting only those keywords considered as having a higher likelihood of being useful (e.g., only proper nouns). The rule engine 79 alters its extraction behavior depending upon the type of program being watched.

Each extraction policy, Pₑ, corresponds to a subset of the rules in R. This mapping can either be preset, or it can be learned. The mapping essentially defines the kinds of patterns to be used for extracting keywords 76 from a particular type (genre) of program. In one example, the mapping can be determined by conducting a small user study involving four subjects asked to mark the keywords they would like to search for from CC transcripts of four types of sample programs: News, Sitcom, Talk Show and Reality TV. The transcripts were then tagged using Brill's tagger and the tags of the marked keywords were extracted as rules (e.g., if the keyword “Global Warming” in a news program was marked, and if the words were tagged “Global<ADJ> Warming<NOUN>”, then “<ADJ><NOUN>” is extracted as a rule for the genre “news”). The top ranking rules (based on frequency and a threshold) were used as the rules that form the extraction policy for that kind of program and the union of all rules for all types of programs forms R. This facilitates reusability of rules and extraction policies. The rule engine 79 applies the extraction policy on the text received from the tagger 73 and extracts keywords from it. These keywords are then weighted based on whether they occur in the most recent window. The weighted keywords are then ordered and presented to the user.

The extracted keywords identify information of potential interest to the user. The query resolution function 27 enables extracting data related to identified data of potential interest to the user, aggregating the extracted data and correlating the aggregated data. Such correlation involves identifying associations between data. For example, data A is ‘similar to’ or the ‘same as’ data B.

The query resolution function 27 can be implemented, e.g., in a stand-alone module, in a device 20 such as a set-top box or in a CE device 30 such as a DTV. An example implementation of extracting, aggregating and correlating data by the query resolution function 27 utilizing query plans is described below. XML-based execution plans are provided which encapsulate the steps involved in a search query resolution process. An execution plan comprises one or more plan-steps and each plan-step essentially specifies the type of task (i.e., data extraction, aggregation or correlation) to be performed.

Further, special classes, termed RuleLets, are provided to execute the three tasks (i.e., data extraction, aggregation or correlation) in a typical query resolution process. The RuleLets are: GetDataRuleLet, MergeDataRuleLet and GetContentNotInHomeRuleLet. The GetDataRuleLet obtains data from different data sources, the MergeDataRuleLet merges data obtained from different data sources and the GetContentNotInHomeRuleLet identifies the data/content (from a collection of data extracted from different sources) that are not available on the home devices.

A plan-step essentially specifies the RuleLet to be executed and the set of input and output parameters required for the execution of the RuleLet. The specific fields in a plan-step include the name of the RuleLet to be executed, the input data required for the RuleLet execution, the output-type expected from the execution of the RuleLet and the scope of the desired output data (if applicable). The scope field is used to specify whether the required data should be available in the home (“Local”) or on the “Internet.” In order to cater to different kinds of search queries, a plan library containing different kinds of plans is maintained. When a user chooses a search query, the query resolution function 27 identifies a plan based on the context of the user (e.g., if the user is watching a TV program, DVD or music video, or listening to a music album).

The use of execution plans in a search scenario in conjunction with example execution plans is described below. The search scenario involves a case where a user is watching a broadcast documentary program titled “Drumming Techniques” on a TV. When the user expresses interest to access related Internet content, the search facilitator 24 identifies and displays potential search queries from the program's closed captions (using the techniques described above) by executing the following plan steps: obtain the EPG related to the TV program being watched by the user; obtain keywords from the EPG information obtained in the previous step; obtain the genre of the TV program; based on the genre obtain significant keywords from the closed captions of the TV program; and merge the keywords identified from the EPG and the closed captions. An XML version of such a plan comprises:

```
<?xml version=“1.0” ?>
<Plan>
      <Plan-step>
    <RuleLet>GetDataRule</RuleLet>
    <OutputType>EPGInfo</OutputType>
    <Scope>Internet</Scope>
  </Plan-step>
      <Plan-step>
    <RuleLet>GetDataRule</RuleLet>
    <InputType>EPGInfo</InputType
    <OutputType>KeywordsFromEPG</OutputType>
    <Scope>Local</Scope>
  </Plan-step>
  <Plan-step>
    <RuleLet>GetDataRule</RuleLet>
    <OutputType>ProgramGenre</OutputType>
    <Scope>Local</Scope>
  </Plan-step>
  <Plan-step>
    <RuleLet>GetDataRule</RuleLet>
    <InputType>ProgramGenre</InputType
    <OutputType>KeywordsFromCaptions</OutputType>
    <Scope>Internet</Scope>
  </Plan-step>
  <Plan-step>
    <RuleLet>MergeDataRule</RuleLet>
    <InputType>KeywordsFromEPG</InputType>
    <InputType>KeywordsFromCaptions</InputType>
    <OutputType>LiveTVKeywords</OutputType>
    <Scope>Local</Scope>
  </Plan-step>
</Plan>
```

The keywords obtained by executing this plan are then displayed to the user. One of the keywords/potential search queries displayed is: “Polyrthymic Drumming”. The user chooses “Polyrthymic Drumming” and expresses interest to see more related videos that the user has not seen before. To resolve this request, the facilitator 24 executes a plan, with “Polyrthymic Drumming” set as the keyword, including the plan steps: obtain videos related to the keyword (“Polyrthymic Drumming”) that are available on the Internet sources 66 (FIG. 2); identify pre-recorded videos available in the home related to “Polyrthymic Drumming”; filter out videos in the list resulting after the last step that are already available in the local sources 69. An XML version of such a plan comprises:

```
  <?xml version=“1.0” ?>
<Plan>
  <Plan-step>
    <RuleLet>GetDataRule</RuleLet>
    <InputType>Keyword </InputType
    <OutputType>RelatedVideos</OutputType>
    <Scope>Internet</Scope>
  </Plan-step>
  <Plan-step>
    <RuleLet>GetDataRule</RuleLet>
    <InputType>Keyword </InputType>
    <OutputType>RecordedVideos</OutputType>
    <Scope>Local</Scope>
  </Plan-step>
  <Plan-step>
    <RuleLet>GetContentNotInHomeRule</RuleLet>
    <InputType>RelatedVideos</InputType>
    <InputType>RecordedVideos</InputType>
    <OutputType>InternetVideosNotInHome</OutputType>
    <Scope>Local</Scope>
  </Plan-step>
</Plan>
```

The related Internet videos that are not already available in the local sources 69 are displayed to the user on the client module.

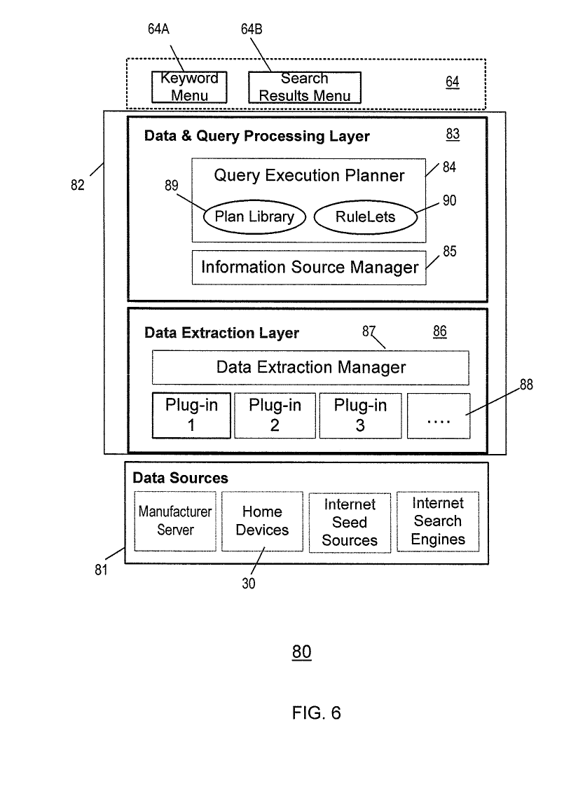

FIG. 6 shows an example functional architecture 80 for the facilitator system implemented as a context-specific search facilitator system (CSF) 82. The CSF 82 provides query identification functions (e.g., keyword extraction) and query resolution functions (e.g., data extraction, aggregation and correlation), as described above. The CSF 82 includes different layers to enable seamless CE device and Internet content from the data sources 81 for search and access.

The CSF 82 includes a data and query processing (DQP) layer 83. The DQP 83 assists in resolving user queries and also provides an API for client applications 64 to make use of. Though client applications 64 are shown external to the CSF 82, the client applications 64 can also be components of the CSF 82. The DQP 83 includes a query execution planner (QEP) 84 and an information source manager (ISM) 85. The CSF 82 further includes a data execution (DE) layer 86. The DE 86 includes a data extraction manager (DEM) 87 and multiple plug-ins 88.

The QEP 84 provides interfaces for client applications to search for and access locally available data (i.e., data stored on the devices 30 and/or 20) and related data available on the Internet. The QEP 84 maintains a plan library 89, containing a set of pre-defined execution plans that are used to resolve requests for data. The QEP 84 also maintains the RuleLet 90 classes that are executed as part of a plan. When the QEP 84 receives a query from a client application, the QEP 84 retrieves the relevant plan from its plan library 89 and executes it. During the plan execution, the QEP 84 gathers the information/content requested by the user using the plug-ins 88 in the data extraction layer 86 (via the ISM 85). The ISM 85 manages a directory containing details about the types of data each data extraction plug-in component could extract and the input data (if any) expected by the plug-ins 88 to do so. This allows the QEP 84 to identify the plug-in 88 that provides a specific type of data.

The DE 86 includes many plug-ins 88 for extracting content/information from local and Internet data sources. 81 Local data sources refer to, e.g., home devices. Internet data sources include seed sources (e.g., BarnesandNoble.com, YouTube.com) and Internet search engines (e.g., Google, Yahoo). The functionalities provided by the different plug-ins 88 include: (1) A web scraper plug-in allows extracting specific information from specific websites; (2) A content manager plug-in allows accessing media content stored on the home devices; (3) An Internet video search plug-in allows searching for and accessing video content on the Internet; (4) A closed caption analyzer plug-in allows analyzing and identifying keywords from TV captions; and, (5) An EPG plug-in allows obtaining the EPG information for TV programs.

The DE 86 manages the plug-ins 88 and allows new plug-ins 88 to be added or removed with minimal code changes and provides an application programming interface for the higher-level components to use the plug-ins.

As an example of a search facilitation process by the CSF 82, according to the present invention, wherein a TV viewer accesses the Internet is as follows A user Trisha is watching a TV program on her TV about “Drumming Techniques” and is intrigued by the video. She wishes to learn more about the topics discussed in the program, especially about “Polyrhythmic drumming” which has just been mentioned. She presses a button on her TV remote control 31 and finds a host of information regarding the program being watched. A UI graphic on the client module screen shows two menus. One menu 64A provides a list of keywords related to the TV program (assembled by the query identification function of the CSF 82), and the first keyword “Polyrhythmic Drumming” is highlighted. The other menu 64B shows a list of search results (assembled by the query resolution function of the CSF 82) including web links containing information and/or videos related to the keyword “Polyrhythmic Drumming”. Trisha notices that the second link on this menu is a “how to” video. Using the navigation buttons on her remote control she highlights this link, and then presses the “enter” button to select the video and start viewing it.

The above scenario illustrates the following essential features: first, the user need not enter text or queries at any point; interaction is via the navigation buttons on a conventional remote control. Second, the user is able to access desired related Internet information by pushing a few buttons, as there is no need to bring up a search page or enter search terms. In this scenario, the context of the user (the program being watched), helps focus the search to relevant content.

The process for providing relevant information to a user of a CE device on a local network such as a home network generally involves:
1. Gathering information about current activities of the user on the local network (e.g., listening to a song, watching a TV program);
2. Gathering contextual information about current user activity on the local network (e.g., finding the metadata of a song or a TV program);
3. Obtaining additional information interrelated to the information gathered in the above steps from other sources, such as the devices on the local network and/or information from external sources such as the Internet (e.g., obtaining information related to a song or a TV program);
4. Identifying correlations in the information obtained in the above steps;
5. Using the correlations in forming queries to search for information in local and/or external sources such as the Internet; and
6. Presenting the search results to the user as information related to the current user activity (i.e., information of interest to the user).

Identifying correlations can be performed in one or more of the following example ways: (1) identifying correlations between information about current user activity and the interrelated information obtained from local sources, (2) identifying correlations between information about current user activity and the interrelated information obtained from external sources, and (3) identifying correlations between information about current user activity and the interrelated information obtained from local and external sources.

In order to minimize the number of keystrokes a user has to enter to receive information related to the current user activity, functionalities that support information searching are mapped to a small number of keys (e.g., mapping searches to a few keys of a remote control). Then, certain information is gathered about current user activity on CE devices. This includes obtaining metadata contained in media that is accessible only by content-rendering CE devices (e.g., the length and type of content contained in a CD or a DVD).

The process further involves obtaining information embedded in broadcast streams that are accessible only by a receiving/rendering CE device (e.g., subtitles and closed captions). In addition, information is gathered about content already existing on the home network (e.g., songs by Sting that are already owned by the user and the corresponding metadata). Further information is gathered about relevant structured data that exists on the Internet (e.g., gathering metadata about the songs already owned by the user from a compact disk database (CDDB)). Additional relevant information is obtained from semi-structured data that exists on the Internet (e.g., the biography of an artist from the Internet Movie Database (IMDb) and/or from the relevant web pages). Further relevant information is gathered from unstructured data that exists on the Internet (e.g., URLs of the web pages carrying the geographical, economical, political and cultural information about the place from which main events are being reported in the news).

The gathered/obtained information defines the information at hand. Then, when a user operates a CE device, what the user inputs to a CE device is correlated with the information at hand to automatically form queries to search for related information. This minimizes the need for the user to generate queries or use a keyboard in forming queries.

Then, from the information at hand, the data extracted from the Internet sources is correlated with the data extracted from home network content to form a query plan to refine the queries for precise searching. The query plan is then executed for searching the queries on the external network (e.g., the Internet, other resources), without requiring user intervention. The query execution results, in the form of search results, are then presented to the user. Preferably, based on the information at hand, the most relevant information from the search results is selected for presentation to the user, without requiring user intervention. Therefore, the information presented to the user includes information of potential interest to the user as related to the information at hand.

Another example of facilitating searches for the user involves obtaining information about current user activity on a local network, obtaining contextual information about current user activity on the local network, obtaining additional information interrelated to the contextual information and the user activity information, identifying correlations between the additional information, the contextual information and the user activity information, and using the correlations in forming a query to search for information related to the current user activity.

Obtaining additional information may include obtaining additional information interrelated to the contextual information and the user activity information, from sources including the local network and/or external sources. Identifying correlations may include identifying correlations between information about current user activity and interrelated information obtained from local sources. Identifying correlations may include identifying correlations between information about current user activity and the interrelated information obtained from external sources. Identifying correlations may include identifying correlations between information about current user activity and the interrelated information obtained from local and external sources.

Forming a query includes automatically forming a query, without requiring user intervention. The query is executed to obtain search results including information related to the current user activity. Executing the query further may include executing the query to search for related information on the local network and/or external sources. The search results may be presented to the user at this stage on a user interface in a device such as a CE device.

Obtaining information about current user activity on the local network may include obtaining information from user input to the device, or obtaining information from applications running in the network. Obtaining additional information may include obtaining the additional information from external structured data sources. Obtaining additional information may include obtaining additional information that is relevant to user interests from local media content sources.

Obtaining additional information may include obtaining the additional information from external unstructured data sources, from external semi-structured data sources, or from external broadcast data sources.

Obtaining contextual information about current user activity on the local network may include obtaining associated metadata available on the local network. As such forming a query may include using metadata related to the content on the local network for determining a context for query formation. Further, determining a context for query formation may include using metadata related to the content in the network and information from applications on the local network, to determine a context for query formation without requiring user intervention. The query may be used to search the Internet for information related to the current user activity or interest. As such, the above processes also enable improved access to the Internet to the users of CE devices.

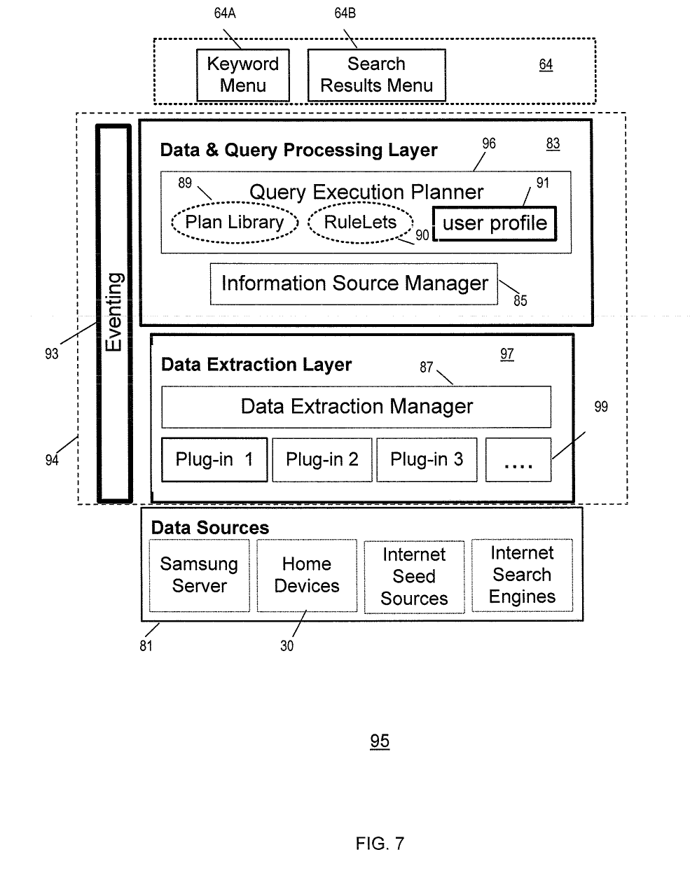

The query identification function 25 (FIG. 2) further functions as a query formation module that may form queries based on user request, or based on user interests, or based on user interaction with the CE device 30, etc. FIG. 7 shows an alternative architecture 95 for facilitating searching using execution plans, according to the invention. Specifically, the architecture 95 provides a facilitator system implemented as a context-specific search facilitator system (CSF) 94. According to the CSF 94, the DQP layer 83 includes a QEP 96 which implements a user profile 91, in addition to said plan library 89 and RuleLets 90. Further, the CSF 94 includes an eventing module 93. Compared to the QEP 84 (FIG. 6), the QEP 96 of architecture 95 provides an alternate function for execution to enable resolving user queries in a personalized and asynchronous fashion.

Asynchronous resolution of queries may be beneficial for at least two reasons. First, if requested data is not available at the time of the query, the requested data can be provided to the user whenever it becomes available (without requiring the user to re-submit the query). Second, if the requested data is available at the time of the query, not only can the requested data be provided to the user immediately, but also continual data updates may be provided to the user as a background process. As such, the user is shown up to date data relevant to the user query.

According to the QEP 84 (FIG. 6) an execution plan comprises: one or more plan steps and a plan step includes the name of the RuleLet to be executed, the set of input/output parameters required for the execution of the RuleLet and the desired scope for the requested data. In the alternate QEP 96, a plan includes two additional fields/attributes: (1) a plan-id, and (2) a query-id. The query-id is a unique identifier for a specific user query. The query-id is generated when a new user query is received. A plan-id is a unique identifier for the execution plan, and is used to identify the plan executed for a particular user query. In one example, pid1 is an instance of plan-id, and qid1 is an instance of query-id. Other representations may be used, such as ad numerical representation (e.g., 500, 600) for the plan-id and the query-id. A sample execution plan including a plan-id and query-id, to obtain keywords related to, e.g., the current TV program, comprises:

```
<?xml version=“1.0” ?>
<Plan id =“pid”>
      <Plan-step>
    <RuleLet>GetDataRule</RuleLet>
    <QueryId>qid1</QueryId>
    <OutputType>EPGInfo</OutputType>
    <Scope>Local</Scope>
  </Plan-step>
      <Plan-step>
    <RuleLet>GetDataRule</RuleLet>
    <InputType>Local-EPGInfo</InputType>
    <OutputType>KeywordsFromEPG</OutputType>
    <Scope>Local</Scope>
  </Plan-step>
  <Plan-step>
    <RuleLet>GetDataRule</RuleLet>
    <QueryId>qid1</QueryId>
    <OutputType>ProgramGenre</OutputType>
    <Scope>Local</Scope>
        </Plan-step>
    <Plan-step>
    <RuleLet>GetDataRule</RuleLet>
    <QueryId>qid1</QueryId>
    <InputType>ProgramGenre</InputType
    <OutputType>KeywordsFromCaptions</OutputType>
    <Scope>Internet</Scope>
  </Plan-step>
  <Plan-step>
    <RuleLet>MergeDataRule</RuleLet>
    <InputType>KeywordsFromEPG</InputType>
    <InputType>KeywordsFromCaptions</InputType>
    <OutputType>LiveTVKeywords</OutputType>
    <Scope>Local</Scope>
  </Plan-step>
</Plan>
```

The plug-ins 88 in the data extraction layer 87 (FIG. 6) provided any requested data in a synchronous fashion (i.e., if a plug-in 88 receives a request for some data, it returns the appropriate data available at that point immediately and does not provide any updates to the data asynchronously). In the alternate architecture (FIG. 7), the data extraction layer 97 includes plug-ins 99 which support the eventing module 93 (e.g., based on UPnP), providing the ability to update data initially presented to the user (or, if there was no data available initially, then newly available data is presented to the user). The QEP 96 provides the query-id for each user query to the plug-ins 99. The plug-ins 99 use the eventing module 93 to provide updates and new data related to each user query. The plug-ins 99 use the query-id of a user query to identify data updates (or new data) intended for that user query.

Upon receiving a query from the client, the QEP 84 (FIG. 6), retrieves the relevant plan from its plan library, executes it using the ISM 85 and data extraction plug-ins 88, and returns back the data results of the execution to the client/user. In the alternate architecture (FIG. 7), upon receiving a user query (request) from the client 64, the QEP 96 generates a query-id. The QEP 96 then selects a plan from the plan library 89 to execute to satisfy the query, wherein the plan is identified by a plan-id. The QEP 96 stores the query-id and the plan-id in a local workspace.

The QEP 96 then executes the selected plan step-by-step, while passing on the generated query-id for the corresponding query to the plug-ins 99 (if specified in the plan step to do so). In response, the plug-ins 99 return query results (e.g., new data or data updates to the data sent initially) using events, along with said query-id, via the eventing module 93. The QEP 96 then checks the selected plan (e.g., look-up using the plan-id associated with the query-id), to determine if there are any plan steps that need to be re-executed because of the updates/new data returned by the plug-ins 99, and executes any such plan steps accordingly.

Further, the QEP 96 maintains a user profile in the user profile module 91, wherein the user profile comprises the preferences of the user (e.g., user preference about if/when the user wishes to see new keywords on the UI 64A). The QEP 96 may use the user profile to customize/rank the query results generated by execution of the selected plan.

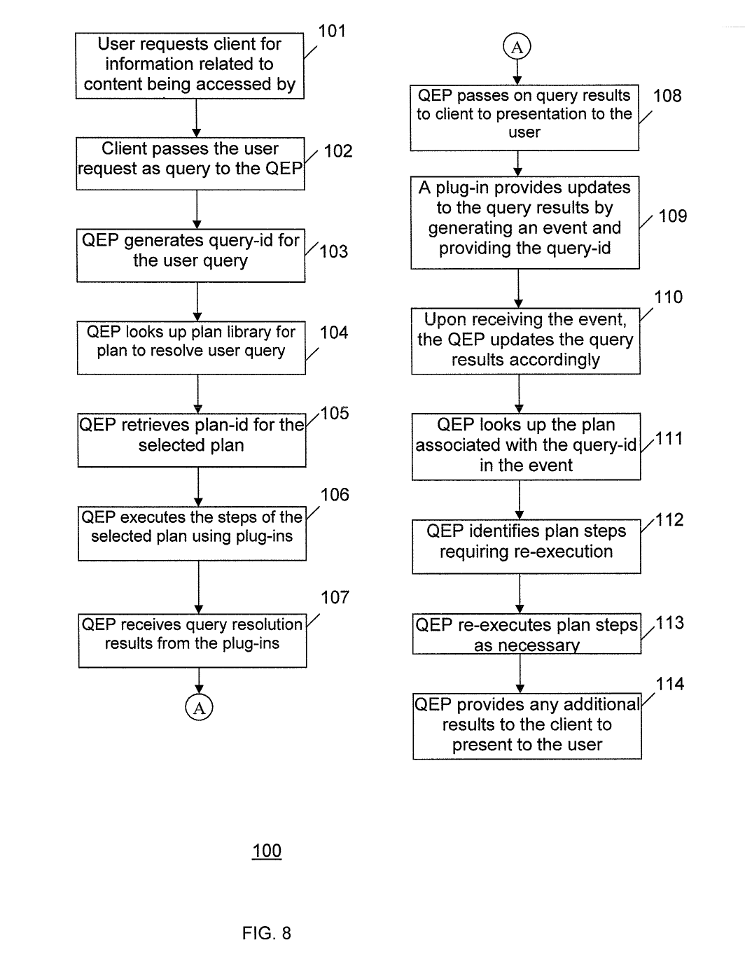

FIG. 8 shows a flowchart of an example search facilitation process 100 for resolving a user query related to content being accessed by the user, such as obtaining keywords related to a TV program, using the architecture 95. The process 100 includes the following steps:
101. A user requests for information (keywords) related to content being accessed by the user, such as a current TV program.
102. The client application 64 passes on the user request as a query to the QEP.
103. The QEP generates a query-id for the user query.
104. The QEP looks-up the plan library to select an appropriate plan to execute to resolve the user query (e.g., the QEP selects
105. 3 as the plan to execute).
106. The QEP retrieves the plan-id
107. (3) for the selected plan and stores the plan-id along with the query-id in a local store.
108. The QEP executes the steps in the selected plan using the plug-ins 99, wherein one example plan to resolve a query for keywords related to a TV program being accessed by the user is executed by the QEP as follows:
   a. Obtain the EPG information for the TV program being watched by the user;
   b. Obtain keywords from the EPG information using a plug-in;
   c. Obtain the genre of the TV program being watched;
   d. Obtain keywords from the closed captions of the TV program using a plug-in; and
   e. Merge the keywords obtained in steps 106b and 106d and rank based on any user preferences.
   While executing steps 106a, 106c and 106d, the QEP passes on the query-id to the plug-ins 99 in addition to other inputs specified in the corresponding plan step in the selected plan.
109. The QEP stores the query resolution results obtained (steps 106a-d) in a local workspace along with the query-id.
110. The QEP passes on the results of the final step to the client.
111. A plug-in that provided query results (e.g., keywords from closed captions during step 106d) sends an event to the QEP updating the results (e.g., updating the list of keywords) the plug-in had provided earlier, along with the corresponding query-id.
112. On receiving this event, the QEP updates the query results (e.g., results from step 106d) stored in its local workspace accordingly.
113. The QEP looks up the plan-id corresponding to the selected plan executed for the (query corresponding to the) query-id, sent through the event.
114. Using the plan-id, the QEP identifies all the steps in the plan that may need re-execution due to query result updates in the event (e.g., for plan step 106d, typically steps following step 106d in the plan that require the output of step 106d as an input).
115. The QEP re-executes all the steps identified above (e.g., step 106e is re-executed).
116. The QEP provides the re-execution results, along with the updated results in its workspace, as a merged list to the client to present to the user.

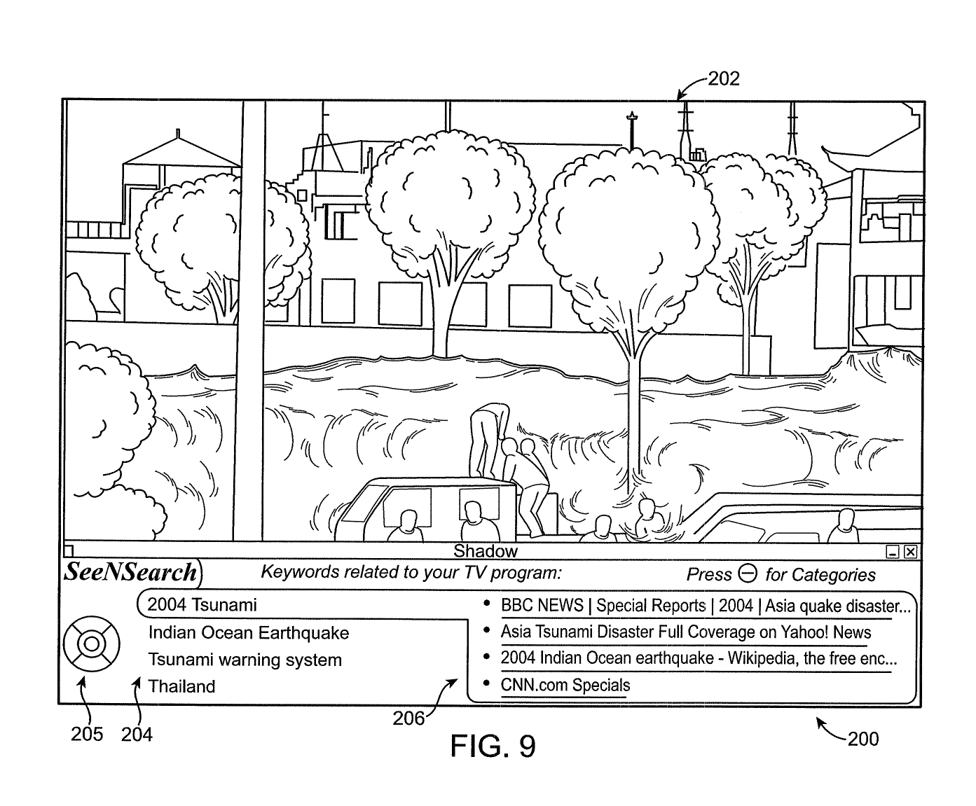

FIG. 9 shows an example screen shot of a user interface 200 facilitating information searching, according to the invention. If the TV program is a news program 202 about natural disasters, and the related keywords 204 generated by the query identification function 25 are “2004 Tsunami”, “Indian Ocean Earthquake”, “Tsunami Warning”, and “Thailand”. Then if the user selects the keywords “2004 Tsunami” for searching using the selector 205, the query resolution function 27 provides search results 206 for a query based on the selected keyword.

As is known to those skilled in the art, the aforementioned example architectures described above, according to the present invention, can be implemented in many ways, such as program instructions for execution by a processor, program product stored on a computer useable medium, computer implemented method, as logic circuits, as an application specific integrated circuit, as firmware, etc. The present invention has been described in considerable detail with reference to certain preferred versions thereof, however, other versions are possible. Therefore, the spirit and scope of the appended claims should not be limited to the description of the preferred versions contained herein.

What is claimed is:

1. A method of facilitating information searching for a user of an electronic device, comprising the steps of:
forming a query to search for information related to the user activity on the electronic device;
resolving the query by searching available sources including one or more external sources for said related information;
receiving an event indicating availability of related information; and
providing the related information to the user.

2. The method of claim 1 wherein the step of resolving the query includes resolving the query by searching said available sources, and providing extracted related information to the user.

3. The method of claim 2 wherein:
the step of receiving an event indicating availability of the related information further includes receiving an event indicating availability of additional related information; and
the step of providing the related information to the user further includes providing said additional related information to the user.

4. The method of claim 2 wherein the step of resolving the query further includes providing an identifier for the query and submitting the query and the query identifier to a data extractor for extracting related information by searching said available sources.

5. The method of claim 4 wherein the step of receiving an event indicating availability of the related information includes receiving an event from the data extractor including the query identifier and extracted related information.

6. The method of claim 5 wherein the step of providing the related information to the user further includes providing the related information to the user in response to a query identified by the query identifier.

7. The method of claim 5 wherein:
the step of resolving the query further includes: selecting a plan for resolving the query, the plan including plan steps and having an identifier; and submitting the selected plan and the query identifier to the data extractor for executing the plan steps to extract data by searching said available sources;
the step of receiving an event indicating availability of the related information further includes: receiving an event from the data extractor including the query identifier and additional related information; and re-executing any of the steps of the plan based on the additional related information as necessary.

8. The method of claim 2 further including maintaining a user profile indicating user preferences, such that providing the related information to the user includes customizing presentation of the extracted related information based on the user profile.

9. The method of claim 1, wherein the electronic device comprises a consumer electronics device.

10. The method of claim 1, wherein the user activity represents user interests, such that forming a query includes forming a query for information related to the user interests.

11. The method of claim 1, wherein forming a query comprises forming a query based on user request for information related to current content accessed by the user on the electronic device.

12. An apparatus for facilitating information searching for a user of an electronic device, comprising:
a query formation module configured for forming a query to search for information related to the user activity on the electronic device;
a query resolver configured for resolving the query by searching available sources including one or more external sources for said related information, and receiving an event indicating availability of related information; and
an interface function configured for providing the related information to the user.

13. The apparatus of claim 12 wherein the query resolver is further configured for resolving the query by searching said available sources, such that the interface function provides the extracted related information to the user.

14. The apparatus of claim 13 wherein:
the query resolver is further configured for receiving an event indicating availability of additional related information; and
the interface function is further configured for providing said additional related information to the user.

15. The apparatus of claim 13 wherein the query resolver is further configured for providing an identifier for the query and submitting the query and the query identifier to a data extractor for extracting related information by searching said available sources.

16. The apparatus of claim 15 wherein the query resolver is further configured for receiving an event from the data extractor including the query identifier and extracted related information.

17. The apparatus of claim 16 wherein the interface function is further configured for providing the related information to the user in response to a query identified by the query identifier.

18. The apparatus of claim 16 wherein:
the query resolver is further configured for: selecting a plan for resolving the query, the plan including plan steps and having an identifier; and submitting the selected plan and the query identifier to the data extractor for executing the plan steps to extract data by searching said available sources; and
the query resolver is additionally configured for: receiving an event from the data extractor including the query identifier and additional related information; and re-executing any of the steps of the plan based on the additional related information as necessary.

19. The apparatus of claim 13, wherein the query resolver is further configured for maintaining a user profile indicating user preferences, such that the interface function provides the related information to the user by customizing presentation of the extracted related information based on the user profile.

20. The apparatus of claim 12, wherein the user activity represents user interests, such that the query formation module is further configured for forming a query for information related to the user interests.

21. The apparatus of claim 12, wherein the query formation module is further configured for forming a query based on user request for information related to current content accessed by the user on the electronic device.

22. A system for facilitating information searching for a user, comprising:
an electronic device for access to content
a facilitator including:
a query formation module configured for forming a query to search for information related to the user activity on the electronic device; and
a query resolver configured for resolving the query, and receiving an event indicating availability of related information; and
an interface function configured for providing the related information to the user via the electronic device.

23. The system of claim 22 further including a data extractor wherein the query resolver is further configured for resolving the query by submitting the query to the data extractor for searching said available sources, and receiving an event from the data extractor indicating availability of additional related information, wherein the interface provides said additional related information to the user via the client device.

24. A program product stored on a computer useable medium for facilitating information searching for a user of an electronic device, the program product comprising program code for causing a computer system to perform the following steps:
forming a query to search for information related to the user activity on the electronic device;
resolving the query by searching available sources including one or more external sources for said related information;
receiving an event indicating availability of related information; and
providing the related information to the user.

25. A computer-implemented method for facilitating information searching for a user of an electronic device, comprising:
forming a query to search for information related to the user activity on the electronic device;
resolving the query by searching available sources including one or more external sources for said related information;
receiving an event indicating availability of related information; and
providing the related information to the user.
